(19) United States
(12) Patent Application Publication
(10) Pub. No.: US 2020/0028133 A1
(43) Pub. Date: Jan. 23, 2020

(54) SYSTEMS AND METHODS COMPRISING OPEN CELL PACK MODULES

(71) Applicant: Maxwell Technologies, Inc., San Diego, CA (US)

(72) Inventors: Kevin T. Stone, San Diego, CA (US); Laurent Gisler, Belfaux (CH); Ishmael D. Rahimian, San Diego, CA (US)

(21) Appl. No.: 16/498,328

(22) PCT Filed: Mar. 29, 2018
(86) PCT No.: PCT/US2018/025276

§ 371 Date: Sep. 26, 2019

Related U.S. Application Data
(60) Provisional application No. 62/479,714, filed on Mar. 31, 2017.

(51) Int. Cl. H01M 2/10; H01G 11/10; H01G 11/84; H01R 25/16; H01M 2/20

(52) U.S. Cl. CPC H01M 2/1077; H01G 11/10; H01M 2/202; H01R 25/161; H01M 2/105; H01G 11/84

(57) ABSTRACT

In one aspect, an embodiment of this invention comprises an energy-storage module for storing energy for electrical consumption. The module comprises a plurality of energy-storage cells and a set of parallel walls configured to mount the plurality of energy-storage cells between the parallel walls and having a plurality of through-holes. The module also comprises a bus bar arrangement configured to electrically couple each of the plurality of energy-storage cells to a first terminal and a second terminal and a wire routing device configured to mate with a plurality of the through-holes and configured to receive one or more wires that electrically connect components of the energy storage module.

### BACKGROUND

### Field

The present disclosure relates generally to energy storage devices and systems, such as capacitor and/or battery modules and systems, including ultra-capacitors and super-capacitors, and in particular, capacitor and/or battery modules deployed in low, medium, or high voltage series configurations, each module containing some number of capacitor or battery cells and coupled to some number of other modules.

### Description of the Related Art

Various techniques exist for constructing capacitor and/or battery modules (hereinafter “modules”) used in direct current (DC) systems. Combining the individual capacitor and/or battery cells (cells) into the modules may provide for varied voltages based on a quantity of combined cells. The modules may store power for on demand use by various systems. However, forming the modules is a complicated process, especially as the quantity of cells in the modules increases. The modules may include various components, from spacers that enable proper placement of the cells within the module to conductors that electrically couple the individual cells together to obtain the benefits of the combined voltages. Additionally, the modules may often require cooling components to maintain temperatures of the cells contained therein within an operating range of temperatures.

Accordingly, the prior approaches of constructing the modules to physically and electrically couple the cells require a large number of parts, increasing costs, possible points of failure, module complexity, and maintenance difficulties.

### SUMMARY

Embodiments disclosed herein address the above-mentioned problems with prior art. The systems, methods and devices of this disclosure each have several innovative aspects, no single one of which is solely responsible for the desirable attributes disclosed herein.

Various embodiments of methods and devices within the scope of the appended claims each have several aspects, no single one of which is solely responsible for the desirable attributes described herein. Without limiting the scope of the appended claims, some prominent features are described herein.

In one aspect, an embodiment of this invention comprises an energy-storage module for storing energy for electrical consumption. The module comprises a plurality of energy-storage cells and a set of parallel walls configured to mount the plurality of energy-storage cells between the parallel walls and having a plurality of through-holes. The module also comprises a bus bar arrangement configured to electrically couple each of the plurality of energy-storage cells to a first terminal and a second terminal and a wire routing device configured to mate with a plurality of the through-holes and configured to receive one or more wires that electrically connect components of the energy storage module.

In one other aspect, an embodiment of this invention comprises a method for manufacturing an energy-storage module for storing energy for electrical consumption. The method comprises mounting a set of parallel walls on opposite ends of a plurality of energy-storage cells such that the plurality of energy-storage cells are positioned between the parallel walls, each of the parallel walls having a plurality of through-holes. The method also comprises electrically coupling each of the plurality of energy-storage cells to a first terminal and a second terminal via a bus bar arrangement. The method further comprises mating a wire routing device with a plurality of the through-holes, the wire routing device configured to receive one or more wires that electrically connect components of the energy storage module.

In one other aspect, an embodiment of this invention comprises an energy-storage module for storing energy for electrical consumption. The apparatus comprises means for storing energy between means for mounting the means for storing energy. The apparatus further comprises means for electrically coupling the means for storing energy to a first means for connecting and a second means for connecting. The apparatus also comprises means for routing wire within the energy-storage module.

### BRIEF DESCRIPTION OF THE DRAWINGS

Details of one or more embodiments of the subject matter described in this disclosure are set forth in the accompanying drawings and the description below. Although the examples provided in this disclosure are sometimes described in terms of capacitors or capacitor cells, the concepts provided herein may apply to other types of energy storage systems. Other features, aspects, and advantages will become apparent from the description, the drawings and the claims. Note that the relative dimensions of the following figures may not be drawn to scale.

FIG. 1 illustrates an isometric view of an open cell module comprising a plurality of components that together form the module, in accordance with an embodiment.

FIGS. 2A-2C illustrate embodiments in a top isometric (FIG. 2A), a bottom isometric (FIG. 2B), and a side view (FIG. 2C), respectively, of a terminal bracket used to couple the open cell module of FIG. 1 to a device external to the module.

FIGS. 3A-3C illustrate embodiments in a top isometric (FIG. 3A), a bottom isometric (FIG. 3B), and a side view (FIG. 3C), respectively, of a bus bar bracket used to couple adjacent cells of the open cell module of FIG. 1 to each other (for example, in series or parallel).

FIG. 4 illustrates a side plate or wall of the open cell module of FIG. 1, in accordance with an embodiment.

FIGS. 5A-5C illustrate an isometric view (FIG. 5A), a top view (FIG. 5B), and a front view (FIG. 5C), respectively, of a wire way or wire routing device, in accordance with an embodiment.

FIG. 6 illustrates an isometric view of the wire routing device of FIG. 5 incorporated into the side plate of FIG. 4 of the open cell module of FIG. 1.

### DETAILED DESCRIPTION

The detailed description set forth below in connection with the appended drawings is intended as a description of exemplary embodiments and is not intended to represent the only embodiments in which the invention may be practiced. The term “exemplary” used throughout this description means “serving as an example, instance, or illustration,” and should not necessarily be construed as preferred or advantageous over other exemplary embodiments. The detailed description includes specified details for the purpose of providing a thorough understanding of the exemplary embodiments. In some instances, some devices are shown in block diagram form.

Energy storage systems can include a plurality of individual capacitor and/or battery cells arranged in series or parallel to form an energy storage module or bank that has a higher voltage output than an individual cell. The modules in turn can be connected in series with other modules to output even higher combined voltages. The individual batteries or capacitors of the energy storage module or bank are sometimes referred to as battery or capacitor cells, or more generally, cells. The individual energy storage modules or banks are sometimes referred to generally as modules.

Depending on the individual cells use in the module, various components may be utilized to form the module. For example, the module may comprise a housing to contain each of the individual cells within a defined volume for ease of transport, installation, etc. The housing may provide structural support for the module as well as provide protection from environmental concerns (for example, debris, moisture, etc.) as needed. Additionally, the module may comprise one or more conductors or bus bars to couple electrically the individual cells to obtain the desired module voltage or circuit structure. In some embodiments, the module may comprise multiple individual bus bars (for example, wires or conductors) that couple an end of each cell to an end of another cell (for example, in a series chain). In some embodiments, the module may comprise multiple bus bars, for example one that couples to one end of each cell and a second that couples to the other end of each cell (for example, in a parallel connection). In some embodiments, the bus bars may connect each cell of the module to a terminal of the module. The terminal of the module may comprise a physical point or connection at which the module is electrically connected or coupled to another module, component, or system. In some embodiments, the module may comprise a plurality of terminals (for example, two, three, four, or more terminals).

In some embodiments, the module may include one or more structural members or fillers that hold the cells in place within the modules. In some embodiments, the structural members or fillers may comprise an epoxy that fills the interior of the module and holds the cells in place. In some embodiments, the fillers may have a solid or liquid state after setting such that the fillers may provide structural support to the cells. In some embodiments, the fillers may also provide thermal benefits to the cells and the module. In some embodiments, the structural members may comprise one or more holders that physically contact more than one of the cells of the modules. For example, the structural members may comprise an array of supports that hold each of the cells to the members and/or to other cells. In some embodiments, the module may comprise one or more interconnects or similar conductors that control various signals between the cells of the module or between modules. However, placing the interconnects or similar conductors within the module between the various cells, the bus bars, and the structural members or fillers may be difficult to do and may result in a physically complex module with minimal free space between the cells within the module. Additionally, the quantity of components and the reduced fill space of the module may result in reduced airflow through the module and, thus, may cause increased temperatures within the module. Thus, the module may utilize supplemental cooling components (for example, fans, etc.) to help maintain the module within safe operating temperatures.

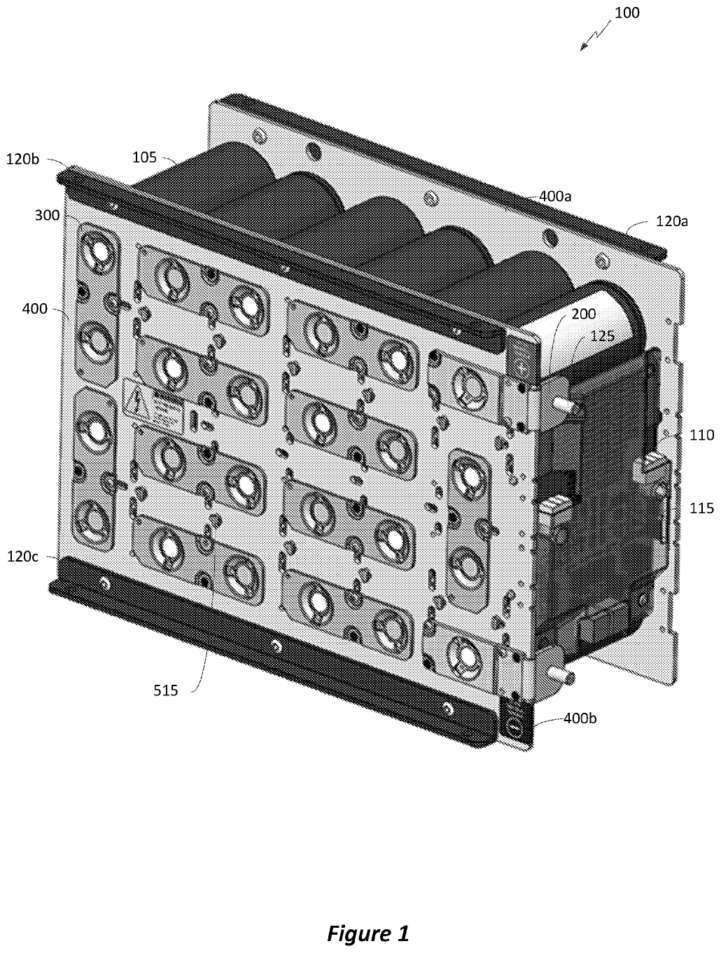

Such congestion within the module may be reduced by utilizing an open cell module structure. The open cell module may not comprise an enclosed module, instead keeping the cells open to the environment of the open cell module. Such an embodiment may have reduced concerns regarding temperatures within the module, as the open-air nature may provide natural cooling for the open cell module. Alternatively, or additionally, instead of each open cell module utilizing its own cooling feature, one or more cooling features may be shared between multiple open cell modules. Accordingly, an interior of the open cell module may have reduced congestion at least due to the removal of the cooling features. Additionally, the open cell module as described herein may utilize a more streamlined module layout as compared to the non-open cell modules. For example, the bus bars used to couple the cells of the open cell module may be positioned on the exterior of the side plates. Accordingly, the interior of the open cell module may have reduced congestion at least due to the removal of all or a majority of the bus bars. Furthermore, the open cell module described herein may utilize wire guides that may be attached to one or both of the side walls but between the cells of the open cell module. For example, the wire guides may comprise structural supports that can be placed in a manner such that the interconnects and other wires within the module or passing through the module are held in place by the structural supports. Such an open cell module as described herein is shown in FIG. 1 and will be described in further detail below.

FIG. 1 illustrates an isometric view of an open cell module 100 comprising a plurality of components that together form the open cell module 100, in accordance with an embodiment. In some embodiments, the open cell module 100 may comprise a plurality of side plates 400a,b one or more bus bar brackets 300, and one or more terminal brackets 200. In some embodiments, the open cell module structure and the components described above may, in combination, form the open cell module 100.

In an embodiment of the open cell module 100 as described herein, the module housing may comprise two side plates 400a,b that are positioned in parallel or substantially in parallel with each other. In some embodiments, the side plates 400a,b may comprise a plurality of openings or cutouts for mounting various components, as will be discussed further below. In some embodiments, the module housing may comprise a printed circuit board (PCB) 110 or similar circuit structure comprising one or more circuits configured to control operation of the open cell module 100. In some embodiments, a protective cover or shield 115 may cover the PCB 110. In some embodiments, the PCB 110 may be integrated with or into, or positioned between one or both of the side plates 400a,b and covered by the cover 115.

The two side plates 400a,b may each be coupled to one or more braces 120a,b. The braces 120a,b may provide mounting capabilities to attach the sides plates 400a,b (and thus the open cell module 100) to a cabinet or other installation point. In some embodiments, each of the side plates 400a,b may be coupled to two braces (for example, side plate 400b may be coupled to braces 120b and 120c) or only one brace (for example, side plate 400a may be coupled to brace 120a). Between the side plates 400a,b, a plurality of cells 105 may be installed. The cells 105 may include the battery or capacitor cells as described herein. In some embodiments, the cells may be held in place with relation to the side plates 400a,b via a plurality of openings or cutouts, as will be described in further detail below. Accordingly, such use of the openings or cutouts may eliminate a need for additional components dedicated to positioning or holding the cells 105 in particular locations within the open cell module 100. In some embodiments, the cells 105 may be held to the side plates 400a,b using various brackets. The brackets may be physically coupled to the cells 105 across or through the side plates 400a,b, thus holding the cells 105 within a particular cutout or opening in each side plate. The brackets may include two styles, bracket 300, which may couple two cells 105 together, or bracket 200, which couples one cell 105 to a terminal pin or post 125.

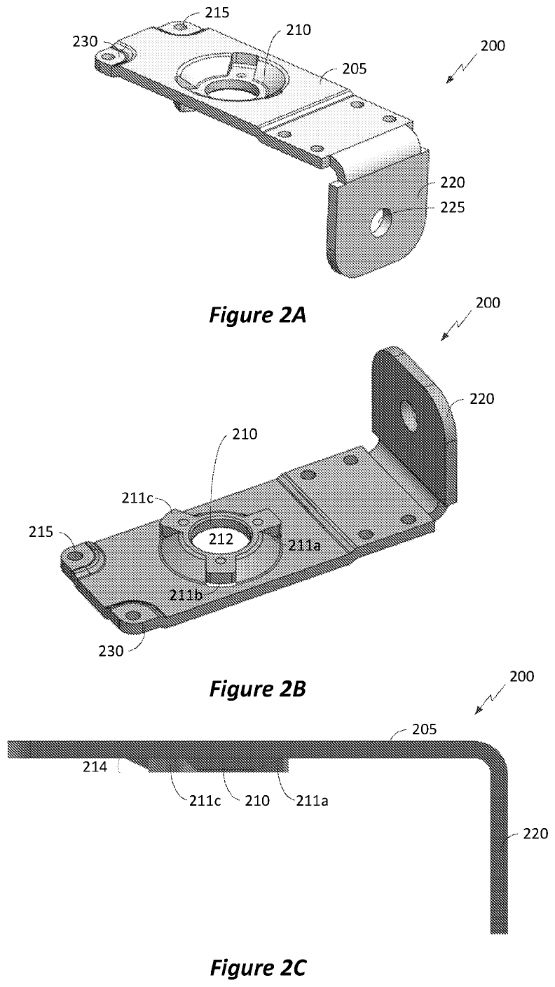

FIGS. 2A-2C illustrate embodiments in a top isometric (FIG. 2A), a bottom isometric (FIG. 2B), and a side view (FIG. 2C), respectively, of a terminal bracket 200 used to couple the open cell module 100 of FIG. 1 to a device external to the open cell module 100. In some embodiments, the terminal bracket 200 may be formed from metal (for example, aluminum, etc.) or some conductive material. In some embodiments, the terminal bracket 200 may include dimples or may not include dimples. For example, the terminal bracket 200 may be formed or stamped as a single piece and then shaped. In some embodiments, the terminal bracket 200 may be formed from two separate pieces that are coupled together. The terminal bracket 200 may include two substantially planar portions that are (or are substantially) orthogonal to each other. The two portions may be mechanically and electrically coupled to each other. Portion 205 may be the portion of the terminal bracket 200 that is placed against one of the side plates 400a,b, as shown in FIG. 1. The portion 205 may include a plurality of holes 215 that pass through the portion 205 in a direction substantially orthogonal to the portion 205. In some embodiments, the holes 215 may be at any angle in relation to the portion 205. In some embodiments, the holes 215 may serve various purposes. For example, one or more of the holes 215 may be used to attach cell pack or cell module 100 sense wires to terminal brackets 200 using rivets (not shown).

Additionally, in some embodiments, the holes 215 may be used to temporarily hold the terminal brackets 200 in place using the rivets prior to the terminal brackets 200 being welded to the individual cells 105. In some embodiments, the rivets may not be needed to hold the terminal brackets 200 or cells 105 in place once the welding of the cells 105 to the terminal brackets 200 has been completed. Additionally, the portion 205 may include a depressed area 210. The depressed area 210 may be depressed into the portion 205 in a direction substantially parallel to the portion 220. In some embodiments, the depressed area 210 may be at any other angle relative to the portion 220. The depressed area 210 may have a hole 212 that passes through the portion 205 and the terminal bracket 200. The depressed area 210 may also include three fingers 211a, 211b, and 211c. The portion 220 may have a single hole 225 that passes through the portion 220. Additionally, one or more of the portions 205 and 220 may include one or more dimples 230.

In some embodiments, the plurality of holes 215 may provide mounting points by which the terminal bracket may be fixedly attached to one or more other components, for example, one of the side plates 400a,b. In some embodiments, one or more of the holes 215 may be included in a depressed region of the terminal bracket 200 (not shown). In some embodiments, one or more of the holes 215 may serve as a path through the terminal bracket 200 for a wire or other conductor or for a non-conductive support piece. In some embodiments, the one or more holes 215 may serve as connection points for a wire or conductor or a mounting point for a rivet to couple the terminal bracket 200 to one of the side plates 400a,b.

In some embodiments, the depressed area 210 may provide a physical and electrical connection through one of the plurality of openings or cutouts of the side plates 400a,b to couple to one of the cells 105 included within the open cell module 100. The depressed area 210 may be configured to pass into and/or through the opening of one of the side plates 400a,b so that the depressed area 210 at least sits within the opening of one of the side plates 400a,b. In some embodiments, the depressed area 210 may extend from the portion 205 by a depressed depth 214. The depressed depth 214 may be large enough such that it can pass through the opening of the side plate (for example, the depressed depth 214 of the depressed area 210 is larger or deeper than a thickness of one of the side plates 400a,b). In some embodiments, the depressed depth 214 may not be large enough that it passes through the opening but rather only rests within the opening of the side plates (for example, the depressed depth 214 is equal to or less than a thickness of one of the side plates 400a,b). In some embodiments, the depressed area 210 may include a plurality of fingers 211a,b,c. As shown, the depressed area 210 includes fingers 211a, 211b, and 211c; however, in some embodiments, the depressed area may only include two fingers (for example, fingers 211a and 211b). In some embodiments, the fingers 211a,b,c may provide for mechanisms of holding or positioning the terminal bracket 200 within the opening of one of the side plates 400a,b while still providing sufficient room for transverse movement of the depressed area 210 within the opening of the side plates 400a,b. Such allowance or permissibility of transverse movement may reduce restrictions and constraints on manufacturing the terminal brackets 200, allowing for greater tolerances in the dimensions, etc., of the terminal brackets 200. In some embodiments, the fingers 211a,b,c may be stamped into the terminal brackets 200 and may improve stamped part manufacturability. In some embodiments, the depressed area 210 may be impact formed (for example, may comprise a cupped feature into the terminal bracket 200 (rather than the cut/bent “fingers”). The hole 212 may allow for a portion of the cell 105 (for example, a terminal on one end of the cell 105) to pass into or through the depressed area 210. Accordingly, the hole 212 may provide for both physical and electrical coupling between the terminal bracket 200, the plates 400a,b and the cell 105. In some embodiments, the cell 105 and the terminal bracket 200 may be coupled together using welding or some other conductive coupling means to ensure both the physical and electrical coupling is maintained.

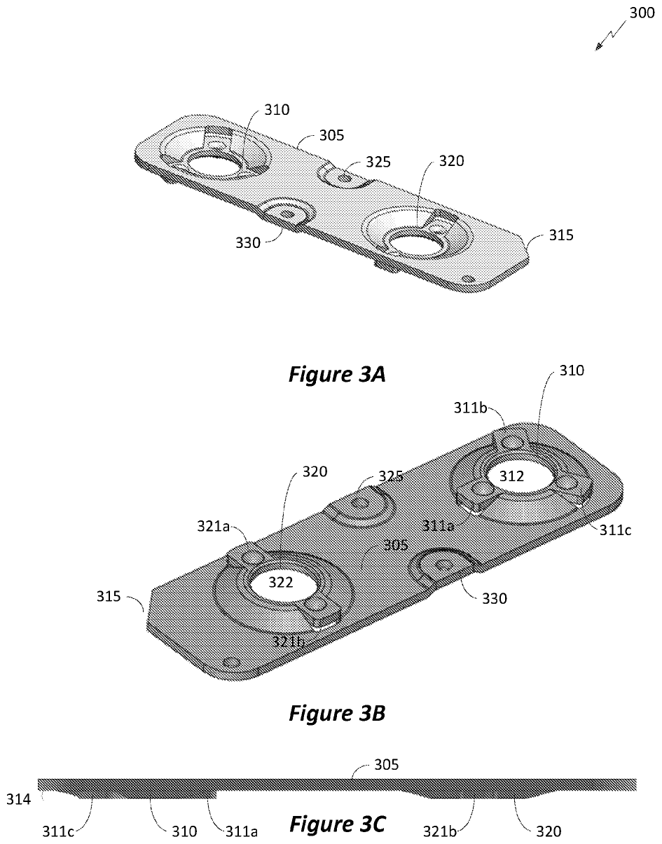

FIGS. 3A-3C illustrate embodiments in a top isometric (FIG. 3A), a bottom isometric (FIG. 3B), and a side view (FIG. 3C), respectively, of a bus bar bracket 300 used to couple adjacent cells 105 of the open cell module 100 of FIG. 1 to each other (for example, in series or parallel). In some embodiments, the bus bar bracket 300 may be formed from a type of metal. The metal may be, for example, aluminum, tin, copper etc. or other conductive material. In some embodiments, the bus bar bracket 300 may include dimples or may not include dimples. For example, the bus bar bracket 300 may be formed or stamped as a single piece of metal and then shaped. In some embodiments, the bus bar bracket 300 may be machined. In some embodiments, the bus bar bracket 300 may be formed from separate pieces that are coupled together. The bus bar bracket 300 may be substantially planar. The bus bar bracket 300 may be placed against one of the side plates 400a,b, as shown in FIG. 1. The bus bar bracket 300 may include a notch 315.

In some embodiments, the notch 315 may provide alignment benefits by simplifying the determination of proper orientation and alignment. In some embodiments, the notch 315 may be replaced with any other orientation and alignment identifying feature, such as a dimple, a protrusion, a different material, and so forth. The bus bar bracket 300 may include a plurality of holes 325 that pass through the bus bar bracket 300 in a direction substantially orthogonal to the planar bus bar bracket 300. In some embodiments, the holes 325 may be at any angle in relation to the bus bar bracket 300. In some embodiments, the holes 325 may provide function or purpose as described above in relation to the holes 215 of the terminal bracket 200. Additionally, the bus bar bracket 300 may the include depressed areas 310 and 320. The depressed areas 310 and 320 may be depressed into the bus bar 300 in a direction substantially orthogonal to the bus bar bracket 300. In some embodiments, the depressed areas 310 and 320 may be at any angle in relation to the bus bar bracket 300. The depressed areas 310 and 320 may each have a hole 312 and 322, respectively, that passes through the bus bar 300. The depressed areas 310 and 320 may also include fingers (for example, fingers 311a, 311b, and 311c and fingers 321a and 321b).

In some embodiments, the plurality of holes 325 may provide mounting points by which the bus bar bracket 300 may be fixedly attached to one or more other components, for example, one of the side plates 400a,b. In some embodiments, one or more of the holes 325 may be included in a depressed region of the bus bar bracket 300 (for example, the dimple 330). In some embodiments, one or more of the holes 325 may serve as a path through the bus bar bracket 300 for a wire or other conductor or for a non-conductive support piece to pass or rest. In some embodiments, the one or more holes 325 may serve as connection points for a wire or conductor (for example, a sense wire connection point to each cell). In some embodiments, the sense wire connection point may alternate between sides of the bus bar bracket 300 (or terminal bracket 200). In some embodiments, the corner hole may only provide coupling of the bracket to a ring lug connection. In some embodiments, the dimples 330 may ensure that the bus bar bracket 300 contacts a face of the cell 105 just prior to an interior face (for example, face of the bus bar bracket 300 facing the side plate) of the bus bar bracket 300 contacting one of the side plates 400a,b. Such dimples 330 may alleviate variations in side plates 400a,b thickness or bus bar bracket 300 thickness or variations in the surfaces of the side plates 400a,b or bus bar bracket 300 that may cause inconsistent laser welds.

In some embodiments, the depressed areas 310 and 320 may provide physical and electrical connections through openings or cutouts of the side plates 400a,b to couple to two the cells 105 included within the open cell module 100. In some embodiments, the bus bar 300 and the depressed areas 310 and 320 may be sized and positioned such that the two cells 105 are adjacent to each other. The depressed areas 310 and 320 may be configured to pass into and/or through the respective openings of the side plates 400a,b so that the depressed areas 310 and 320 at least sit within the openings of the side plates 400a,b. In some embodiments, the depressed areas 310 and 320 may each extend from the portion 305 by a depressed depth 314. The depressed depth 314 may be large enough that it passes through the openings of the side plates 400a,b (for example, the depressed depth 314 of the depressed areas 310 and 320 is larger or deeper than a thickness of one of the side plates 400a,b). In some embodiments, the depressed depth 314 may not be large enough that it passes through the openings but rather only rests within the openings of one of the side plates 400a,b (for example, the depressed depth 314 is equal to or less than a thickness of one of the side plates 400a,b).

In some embodiments, the depressed areas 310 and 320 may include a plurality of fingers 311a,b,c and 321a,b, respectively. As shown, the depressed area 310 includes fingers 311a, 311b, and 311c while the depressed area 320 includes fingers 321a and 321b; however, in some embodiments, the depressed area 320 may only include two (or more) fingers (for example, fingers 321a and 321b) while the depressed area 310 includes three (or more) fingers (for example, fingers 311a, 311b, and 311c). In some embodiments, the fingers 311a,b,c and 321a,b may provide mechanisms of holding or positioning the bus bar bracket 300 within the openings of one of the side plates 400a,b while still providing sufficient room for transverse movement of the depressed areas 310 and 320 within the openings of the side plates 400a,b (and the bus bar bracket 300 along one of the side plates 400a,b). Such allowance or permissibility of transverse movement may reduce restrictions and constraints on manufacturing the bus bar brackets 300, allowing for greater tolerances in the dimensions, etc., of the bus bar brackets 300. In some embodiments, the fingers may provide benefits as described above in relation to the fingers of the terminal bracket 200. The holes 312 and 322 may allow for portions of the cells 105 (for example, a terminal on one end of each of the cells 105) to pass into or through the depressed areas 310 and 320. Accordingly, the holes 312 and 322 may provide for both physical and electrical coupling between the bus bar bracket 300, one of the side plates 400a,b and the cells 105. In some embodiments, the cells 105 and the bus bar bracket 300 may be coupled together using welding or some other conductive coupling means to ensure both the physical and electrical coupling is maintained.

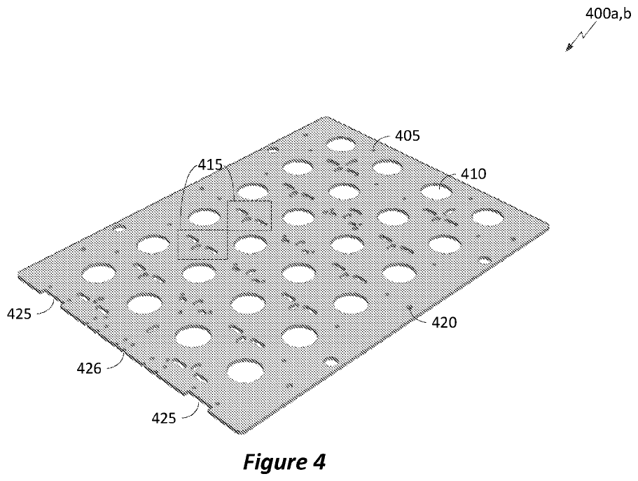

FIG. 4 illustrates a side plate or wall 400a,b of the open cell module 100 of FIG. 1, in accordance with an embodiment. The side plates 400a,b may be formed from any non-conductive, rigid material. For example, the side plates 400a,b may be formed from plastic, resin, or fiberglass. The side plates 400a,b may include a plurality of holes, openings, or cutouts Each of the holes may pass completely through the side plates 400a,b. The holes may be of different shapes, sizes, and/or orientations. For example, the holes 405 may be the smallest of the holes in the side plates 400a,b. The holes 405 may comprise a pathway or “conduit” for wires or conductors that couple to one of the cells 105 of the open cell module 100, the open cell module 100 itself, the PCB 110 of the open cell module 100, or just pass through the open cell module 100. In some embodiments, the holes 405 may provide benefits securing (temporarily or permanently) the terminal and bus bar brackets 200 and 300, respectively, to one of the side plates 400a,b using rivets and/or providing relief for the rivet securing the sense wires to the bus bars as described above in relation to the fingers of the terminal bracket 200. The holes 410 may be the largest of the holes through the side plates 400a,b. The holes 410 may include the portion of one of the side plates 400a,b through which the cells 105 couple to the bus bar or the terminal brackets 300 and 200, respectively.

The holes 410 may be dimensioned such that the fingers 211a,b,c, 311a,b,c, or 321a,b and/or the depressed area 210 may fit within the holes 410 with some extra clearance to provide transverse movement and flexibility with alignment of the cells 105, the brackets 200 or 300, and one of the side plates 400a,b. In some embodiments, the holes 410 may be substantially circular. In some embodiments, the holes 410 may be substantially any other shape. The combination of holes 415 may provide for coupling with a wire way or wire routing device, as described in more detail below. In some embodiments, all or some of the combination of holes 415 may not be used with the wire routing device. In some embodiments, the holes of the combination of holes 415 may be substantially elliptical in shape. In some embodiments, the holes of the combination of holes 415 may be substantially any other shape. The holes or notches 425 along an edge of the side plates 400a,b may comprise locations at which one or more terminal brackets 200 may be attached to the side plate. In some embodiments, the holes or notches 425 may interlock with corresponding notches of the terminal bracket 200 that exist between the portions 205 and 220 (for example, at the 90 degree bend where the two portions 205 and 220 are attached). The interlocking of the side plates 400a,b and the terminal bracket 200 may provide a mechanical interlock between the side plates 400a,b and the terminal bracket 200 that improves resistance to torque when a cable is bolted to the terminal bracket 200. Additionally, notches 426 may comprise locations at which wires or conductors may be fed along the side plates 400a,b. In some embodiments, the notches 426 may provide cutouts for cables or cable ties (or other corresponding components) to lie substantially flush with the side plate while holding the wire harnesses in place. In some embodiment, the hole 225 may be used to insert a terminal node or bar for coupling to other cell modules 100, etc. In some embodiments, the dimples 230 may ensure that the terminal bracket 200 contacts a face of the cell 105 just prior to an interior face (for example, face of the terminal bracket facing the side plate) of the terminal bracket 200 contacting one of the side plates 400a,b. Such dimples 230 may alleviate variations in one of the side plates 400a,b thicknesses that may cause inconsistent laser welds.

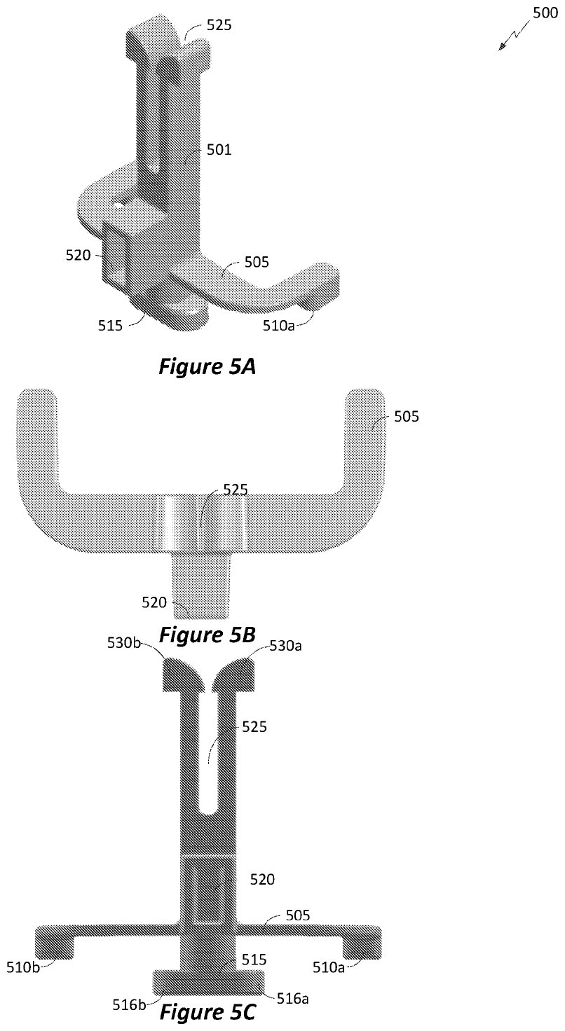

FIGS. 5A-5C illustrate an isometric view (FIG. 5A), a top view (FIG. 5B), and a front view (FIG. 5C), respectively, of a wire way or wire routing device 500, in accordance with an embodiment. In some embodiments, the wire routing device 500 may be formed from a non-conductive, semi-rigid (flexible) material. For example, the wire routing device 500 may be formed from plastic, resin, or fiberglass. In some embodiments, the wire routing device 500 includes a portion 501 that extends substantially vertically from a base of the wire routing device 500. In some embodiments, the base of the wire routing device 500 includes locking tabs 510a and 510b positioned along support arms 505 and locking support 515.

The wire routing device 500 may be configured such that the base is designed to engage with the combination of holes 415 of the side plates 400a,b. For example, the locking support 515 may be configured to pass through one of the holes of the combination of holes 415 of the side plates 400a,b and rotated to “lock” the locking support 515 one a first side of one of the side plates 400a,b. When rotated to lock to one of the side plates 400a,b, the locking support 515 may include tabs or portions 516a,b that, when rotated, prevent the locking support 515 from passing through the respective hole of the combination of holes 415. The routing device 500 may include two support arms 505 that extend horizontally from the portion 501. The support arms 505 may include the locking tabs 510a and 510b on opposite ends of the support arms 505. In some embodiments, the locking tabs 510a and 510b may be configured to “lock” the wire routing device 500 in place when rotated to “lock” the locking support 515 on the first side of one of the side plates 400a,b. When in the “locked” position, the locking support 515 may be on the first side of one of the side plates 400a,b while the support arms 505 and the remainder of the portion 501 is on a second side of one of the side plates 400a,b. Thus, the locking tabs 510a and 510b may be configured to prevent the wire routing device 500 from accidentally rotating and coming loose from the side plates 400a,b. The portion 501 may include a fork or other similarly-shaped elongated members, with a slot 525 between the fork or members. The slot 525 may be configured to hold a wire or conductor in a relative position along one of the side plates 400a,b. Thus, when a series of the wire routing device 500 are positioned in a line along one of the side plates 400a,b using the combination of hole 415, the wire routing devices 500 may provide a path for wires or conductors within the open cell module 100. The interior of the portion 501 forming the slot 525 may be smooth to allow easy movement of the wires or conductors within the slot 525. The top of the slot 525 may include two tabbed portions 530a and 530b that prevent wires or conductors from slipping out of the slot 525 but allow ease of insertion of wires or conductors into the slot 525. For example, the tabbed portions 530a and 530b may include a slanted or curved region that leads into the slot 525. The tabbed portions 530a and 530b may each include a portion that extends from an interior surface of the slot 525 to reduce a gap of the slot 525 to prevent wires or conductors from slipping out of the slot 525 vertically. Additionally, the wire routing device 500 may include a tabbed portion 520. In some embodiments, the recess in the tabbed portion 520 may reduce the volume of the wire routing device 500 and maintain more consistent material thickness of plastic in the injection molded part. In some embodiments, the tabbed portion 520 may provide a finger hold (for example, for a user or installer) to apply torque to the wire routing device 500 during installation in the side plates 400a,b. In some embodiments, the tabbed portion 520 may provide a structural support used to keep the wire routing device 500 “upright” in position once locked into place.

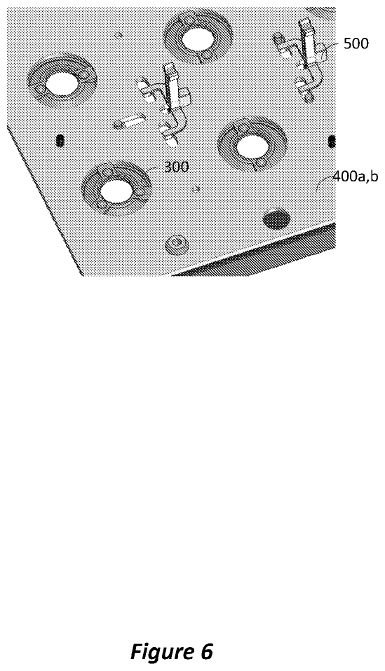

FIG. 6 illustrates an isometric view of the wire routing device 500 of FIG. 5 incorporated into the side plates 400a,b of FIG. 4 of the open cell module 100 of FIG. 1, in accordance with an embodiment.

Other Considerations

It should be understood that any reference to an element herein using a designation such as “first,” “second,” and so forth does not generally limit the quantity or order of those elements. Rather, these designations can be used herein as a convenient wireless device of distinguishing between two or more elements or instances of an element. Thus, a reference to first and second elements does not mean that only two elements can be employed there or that the first element can precede the second element in some manner. Also, unless stated otherwise a set of elements can include one or more elements.

Unless otherwise explicitly stated, articles such as “a” or “an” should generally be interpreted to include one or more described items. Accordingly, phrases such as “a device configured to” are intended to include one or more recited devices. Such one or more recited devices can also be collectively configured to carry out the stated recitations. For example, “a processor configured to carry out recitations A, B and C” can include a first processor configured to carry out recitation A working in conjunction with a second processor configured to carry out recitations B and C.

A person/one having ordinary skill in the art would understand that information and signals can be represented using any of a variety of different technologies and techniques. For example, data, instructions, commands, information, signals, bits, symbols, and chips that can be referenced throughout the above description can be represented by voltages, currents, electromagnetic waves, magnetic fields or particles, optical fields or particles, or any combination thereof.

Various modifications to the implementations described in this disclosure can be readily apparent to those skilled in the art, and the generic principles defined herein can be applied to other implementations without departing from the spirit or scope of this disclosure. Thus, the disclosure is not intended to be limited to the implementations shown herein, but is to be accorded the widest scope consistent with the claims, the principles and the novel features disclosed herein. The word “exemplary” is used exclusively herein to mean “serving as an example, instance, or illustration.” Any implementation described herein as “exemplary” is not necessarily to be construed as preferred or advantageous over other implementations.

Certain features that are described in this specification in the context of separate implementations also can be implemented in combination in a single implementation. Conversely, various features that are described in the context of a single implementation also can be implemented in multiple implementations separately or in any suitable sub-combination. Moreover, although features can be described above as acting in certain combinations and even initially claimed as such, one or more features from a claimed combination can in some cases be excised from the combination, and the claimed combination can be directed to a sub-combination or variation of a sub-combination.

In one or more aspects, the functions described may be implemented in hardware, software, firmware, or any combination thereof. If implemented in software, the functions may be stored on or transmitted over as one or more instructions or code on a computer-readable medium. Computer-readable media includes both computer storage media and communication media including any medium that facilitates transfer of a computer program from one place to another. A storage media may be any available media that can be accessed by a computer. By way of example, and not limitation, such computer-readable media can comprise RAM, ROM, EEPROM, CD-ROM or other optical disk storage, magnetic disk storage or other magnetic storage devices, or any other medium that can be used to carry or store desired program code in the form of instructions or data structures and that can be accessed by a computer. Also, any connection is properly termed a computer-readable medium. For example, if the software is transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio, and microwave are included in the definition of medium. Disk and disc, as used herein, includes compact disc (CD), laser disc, optical disc, digital versatile disc (DVD), floppy disk and Blu-ray disc where disks usually reproduce data magnetically, while discs reproduce data optically with lasers. Thus, in some aspects computer readable medium may comprise non-transitory computer readable medium (e.g., tangible media). In addition, in some aspects computer readable medium may comprise transitory computer readable medium (e.g., a signal). Combinations of the above should also be included within the scope of computer-readable media.

The methods disclosed herein comprise one or more steps or actions for achieving the described method. The method steps and/or actions may be interchanged with one another without departing from the scope of the claims. In other words, unless a specific order of steps or actions is specified, the order and/or use of specific steps and/or actions may be modified without departing from the scope of the claims.

Further, it should be appreciated that modules and/or other appropriate means for performing the methods and techniques described herein can be downloaded and/or otherwise obtained by a user terminal and/or base station as applicable. For example, such a device can be coupled to a server to facilitate the transfer of means for performing the methods described herein. Alternatively, various methods described herein can be provided via storage means (e.g., RAM, ROM, a physical storage medium such as a compact disc (CD) or floppy disk, etc.), such that a user terminal and/or base station can obtain the various methods upon coupling or providing the storage means to the device. Moreover, any other suitable technique for providing the methods and techniques described herein to a device can be utilized.

While the foregoing is directed to aspects of the present disclosure, other and further aspects of the disclosure may be devised without departing from the basic scope thereof, and the scope thereof is determined by the claims that follow.

The scope of the present disclosure is not intended to be limited by the specific disclosures of preferred embodiments in this section or elsewhere in this specification, and may be defined by claims as presented in this section or elsewhere in this specification or as presented in the future. The language of the claims is to be interpreted broadly based on the language employed in the claims and not limited to the examples described in the present specification or during the prosecution of the application, which examples are to be construed as non-exclusive.

The various operations of methods described above may be performed by any suitable means capable of performing the operations, such as various hardware and/or software component(s), circuits, and/or module(s). Generally, any operations illustrated in the Figures may be performed by corresponding functional means capable of performing the operations.

The various illustrative logical blocks, modules, circuits, and method steps described in connection with the embodiments disclosed herein may be implemented as electronic hardware, computer software, or combinations of both. To clearly illustrate this interchangeability of hardware and software, various illustrative components, blocks, modules, circuits, and steps have been described above generally in terms of their functionality. Whether such functionality is implemented as hardware or software depends upon the particular application and design constraints imposed on the overall system. The described functionality may be implemented in varying ways for each particular application, but such embodiment decisions should not be interpreted as causing a departure from the scope of the embodiments.

For purposes of summarizing the disclosure, certain aspects, advantages and novel features have been described herein. It is to be understood that not necessarily all such advantages may be achieved in accordance with any particular embodiment. Thus, the invention may be embodied or carried out in a manner that achieves or optimizes one advantage or group of advantages as taught herein without necessarily achieving other advantages as may be taught or suggested herein.

Various modifications of the above-described embodiments will be readily apparent, and the generic principles defined herein may be applied to other embodiments without departing from the spirit or scope of the application. Thus, the present application is not intended to be limited to the embodiments shown herein but is to be accorded the widest scope consistent with the principles and novel features disclosed herein.

What is claimed is:

1. An energy storage module, comprising:
a plurality of energy-storage cells;
a set of parallel walls configured to mount the plurality of energy-storage cells between the parallel walls and having a plurality of through-holes;
a bus bar arrangement configured to electrically couple each of the plurality of energy-storage cells to a first terminal and a second terminal; and
a wire routing device configured to mate with a plurality of the through-holes and configured to receive one or more wires that electrically connect components of the energy storage module.

2. The module of claim 1, wherein the bus bar arrangement comprises a first plurality of bus bars that each couples to at least two energy-storage cells of the plurality of energy-storage cells and a second plurality of bus bars that each couples to at least one energy-storage cell of the plurality of energy-storage cells and comprises the first or second terminal.

3. The module of claim 2, wherein each of the first and second pluralities of bus bars comprises a depressed portion that extends from a first surface of the bus bar into one through-hole of the plurality of through-holes.

4. The module of claim 3, wherein the depressed portion comprises:
a plurality of protrusions configured to:
hold the bus bar within the one through-hole, and
allow for transverse movement of the depressed portion within the one through-hole; and
an opening that couples to one of the energy-storage cells.

5. The module of claim 3, wherein each of the second plurality of bus bars comprises a terminal portion that extends away from the first surface and includes a hole that extends through the terminal portion, wherein the hole provides for coupling to a terminal node or another module.

6. The module of claim 3, wherein each of the first plurality of bus bars comprises a plurality of depressed portions and wherein a first of the plurality of depressed portions comprises a different number of protrusions than a second of the plurality of depressed portions.

7. The module of claim 3, wherein each of the first plurality of bus bars comprises an indicator that provides identification of an orientation or alignment of the bus bar.

8. The module of claim 3, wherein each of the first and second pluralities of bus bars comprise a hole configured to provide one of a connection point for a conductor or a mounting point to couple the bus bar to the cell holder.

9. The module of claim 3, wherein each of the first and second pluralities of bus bars comprise a dimple that extends away from the first surface and is configured to provide spacing between the bus bar and the cell holder to accommodate variations in bus bar or cell holder thickness and form.

10. The module of claim 1, where the wire routing device comprises a support arm and a locking support, where each of the support arm and the locking support is configured to at least one of extend into or extend through one of the through-holes of the plurality of through-holes.

11. A method for manufacturing an energy storage module, the method comprising:
mounting a set of parallel walls on opposite ends of a plurality of energy-storage cells such that the plurality of energy-storage cells are positioned between the parallel walls, each of the parallel walls having a plurality of through-holes;
electrically coupling each of the plurality of energy-storage cells to a first terminal and a second terminal via a bus bar arrangement; and
mating a wire routing device with a plurality of the through-holes, the wire routing device configured to receive one or more wires that electrically connect components of the energy storage module.

12. The method of claim 11, wherein the bus bar arrangement comprises a first plurality of bus bars that are each coupled to at least two energy-storage cells of the plurality of energy-storage cells and a second plurality of bus bars that are each coupled to at least one energy-storage cell of the plurality of energy-storage cells and where the second plurality of bus bars comprises the first or second terminal.

13. The method of claim 12, wherein each of the first and second pluralities of bus bars comprises a depressed portion that extends from a first surface of the bus bar into one through-hole of the plurality of through-holes.

14. The method of claim 13, further comprising holding, via a plurality of protrusions of the depressed portion, the bus bar within the one through-hole, wherein the plurality of protrusions allow for transverse movement of the depressed portion within the one through-hole and coupling the bus bar to one of the energy-storage cells via an opening in the bus bar.

15. The method of claim 13, further comprising coupling each of the second plurality of bus bars to a terminal node or another module via a terminal portion that extends away from the first surface and includes a hole that extends through the terminal portion.

16. The method of claim 13, wherein each of the first plurality of bus bars comprises a plurality of depressed portions and wherein a first of the plurality of depressed portions comprises a different number of protrusions than a second of the plurality of depressed portions.

17. The method of claim 13, further comprising identifying an orientation or alignment of the bus bar based on an indicator of the bus bar.

18. The method of claim 13, wherein each of the first and second pluralities of bus bars comprise a hole configured to provide one of a connection point for a conductor or a mounting point to couple the bus bar to the cell holder.

19. The method of claim 13, wherein each of the first and second pluralities of bus bars comprise a dimple that extends away from the first surface and is configured to provide spacing between the bus bar and the cell holder to accommodate variations in bus bar or cell holder thickness and form.

20. The method of claim 11, further comprising routing a conductor through the wire routing device, wherein the wire routing device comprises a support arm and a locking support and wherein each of the support arm and the locking support is configured to at least one of extend into or extend through one of the through-holes of the plurality of through-holes.
